(19) United States
(12) Patent Application Publication
(10) Pub. No.: US 2013/0006734 A1
(43) Pub. Date: Jan. 3, 2013

(54) AUTOMATED BIDDING PLATFORM FOR DIGITAL INCENTIVES

(76) Inventors: Matthew Adam Ocko, Palo Alto, CA (US); John Marsland, San Francisco, CA (US)

(21) Appl. No.: 13/244,713

(22) Filed: Sep. 26, 2011

Related U.S. Application Data
(60) Provisional application No. 61/503,602, filed on Jun. 30, 2011.

(51) Int. Cl. G06Q 30/00

(52) U.S. Cl. 705/14.12; 705/14.49; 705/14.57; 705/14.71; 705/14.73

(57) ABSTRACT

An automated bidding system accepts offers for an advertising opportunity within a computer-implemented game. The advertising opportunity may indicate an opportunity to place a branded virtual object in a virtual environment of the computer-implemented game. This bidding system may receive advertising offers for the advertising opportunity from multiple entities, where an advertising offer may include offer attributes that indicate at least a virtual object for the advertising opportunity. The bidding system may also determine opportunity constraints of the advertising opportunity, which are used to select an advertising offer that is appropriate for the advertising opportunity. The bidding system may then selectively accept an advertising offer from an advertising entity based on the offer attributes and the opportunity constraints.

### RELATED PATENT DOCUMENTS

This patent application claims the benefit of priority of U.S. Provisional Patent Application Ser. No. 61/503,602, filed on Jun. 30, 2011, the contents of which is incorporated herein by reference in its entirety.

### TECHNICAL FIELD

The present disclosure relates to providing digital incentives in games and applications based on opportunity constraints. In an example embodiment, an automated platform is provided for digital incentives in computer-implemented virtual games.

### BACKGROUND

Online advertising is largely dominated by advertisements placed on web pages. Typically, advertisers provide an ad network with target keywords for an ad campaign, and the ad network selects an advertisement to place on a host web page by determining which ad campaigns have keywords that best match the content of the web page.

Additionally, some computer-implemented online games also rely on advertising to generate at least a portion of the game's revenue. Unfortunately, these online games typically adopt ad-bidding systems that have been optimized for advertising on web pages, and thus do not make use of special features that are made available by online games.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 illustrates an example of a system for implementing various example embodiments;

FIG. 2 shows an example of a social network within a social graph;

FIG. 3A shows a diagram illustrating example communication messages between example components of an example system;

FIG. 3B shows a flowchart illustrating an example method to accept an advertising offer within a computer-implemented virtual game;

FIG. 3C shows a flowchart illustrating an example method to process an advertising offer within the virtual game;

FIG. 4 shows an example user interface displaying a player's virtual environment on a display screen;

FIG. 5 shows an example pop-up display that presents an offer to a player of the virtual game;

FIG. 6 shows an example user interface displaying a player's virtual environment on a display screen;

FIG. 7 shows a flowchart illustrating an example method to display an acceptable advertising offer to the player of the virtual game;

FIG. 8A shows a flowchart illustrating an example method to generate an advertising offer using an offer-placing script;

FIG. 8B shows a flowchart illustrating an example method to update an advertising offer using an offer-updating script;

FIG. 9 shows a flowchart illustrating an example method to process advertising events associated with the player of the virtual game;

FIG. 10 illustrates an example apparatus, in accordance with various example embodiments;

FIG. 11 illustrates an example data flow between example components of an example system;

FIG. 12 illustrates an example network environment, in which various example embodiments may operate; and

FIG. 13 illustrates an example computing system architecture, which may be used to implement a server or a client system.

### DESCRIPTION OF EXAMPLE EMBODIMENTS

### Overview

Various disclosed embodiments provide a system that processes offers for an advertising opportunity in a computer-implemented game based on opportunity constraints. The advertising opportunity may indicate an opportunity to place a branded virtual object in a virtual environment of the computer-implemented game. For example, this system may receive an advertising offer from an advertiser for this advertising opportunity, where the advertising offer may include offer attributes that indicate at least a virtual object for the advertising opportunity. The advertising opportunity may be one of the following: a menu position within an in-game menu for displaying a branded virtual object; a placement position within the virtual environment for displaying a branded virtual object; a digital coupon redeemable against the price of a physical good or a service; a pop-up offer that is presented to a player of the computer-implemented game; or the like.

The system may selectively accept an advertising offer based on the opportunity constraints of the advertising opportunity. In some example embodiments, selectively accepting the advertising offer involves using an automated process without human intervention. An opportunity constraint may be an inventory constraint of the advertising opportunity, or may be an entity constraint applicable to an advertising entity from which an offer is received. The inventory constraint may include one of the following: a number of advertising opportunities available for displaying a branded virtual object within an in-game market; a number of advertising opportunities available for displaying a branded virtual object within the virtual environment; a number of pop-up views available to present offers to players of the computer-implemented game; or the like. The entity constraint may include one of the following: a virtual object category; a maximum or minimum dimension for a virtual object or image; a list of allowable or restricted image content categories; a list of menu positions within an in-game menu at which a branded virtual object may or may not be displayed; a list of placement positions within the virtual environment at which a branded virtual object may or may not be displayed; a list of restricted words; a list of restricted brand names; a list of restricted products; a list of restricted physical redemption locations; or the like.

In some example embodiments, before the system selectively accepts the advertising offer from the advertiser, the system may first determine at least that the advertising offer does not violate the opportunity constraints of the advertising opportunity. In some embodiments, the system may also determine that the advertising offer is appropriate for a player of the computer-implemented game, and/or that the advertising offer is appropriate for the computer-implemented game. For example, the system may determine that the advertising offer is appropriate for the player based on a game state associated with the player, demographic information for the player, an expected redemption value of the incentive, and/or the like. Moreover, the system may determine that the advertising offer is appropriate for the computer-implemented game based on an inventory constraint, metadata that describes the computer-implemented game, a unique identifier for the physical good or service, and/or the like.

In some embodiments, the system may determine that the advertising offer is appropriate for the computer-implemented game by determining classification data for the physical good or service identified by the unique identifier, and determining that the inventory constraint indicates an available inventory for an advertising offer associated with the classification data. In various embodiments, the system may also determine that the classification data is in-line with a game theme or marketing strategy indicated by the metadata.

In an example embodiment, the system may consider multiple advertising offers for the advertising opportunity, and may select an advertising offer that may indicate an ideal bid amount, and may best satisfy opportunity constraints for the advertising opportunity. For example, an advertiser may submit an advertising offer for a popular brand of bubble gum, such that this offer may include offer attributes that indicate a bid amount and a unique identifier (e.g., a universal product number (UPN) code) for this product. Then, based on these offer attributes, the system may determine that this offer is an ideal advertisement for an advertising opportunity that targets teenage players of, for example, a mafia-based online game. In various example embodiments the offer attributes may indicate at least a unique identifier for a physical good or a service associated with the advertising offer a market restriction that indicates a set of venues at which the digital coupon is not to be presented, a game state of the computer-implemented game at which the digital coupon is to be presented to a user, a coupon price for the physical good or service of the digital coupon, a bid price for an advertising event associated with a user of the computer-implemented game, and a bid price for an incentive that is offered to the user to encourage the user to perform an action associated with the advertising event, or the like.

### Example System

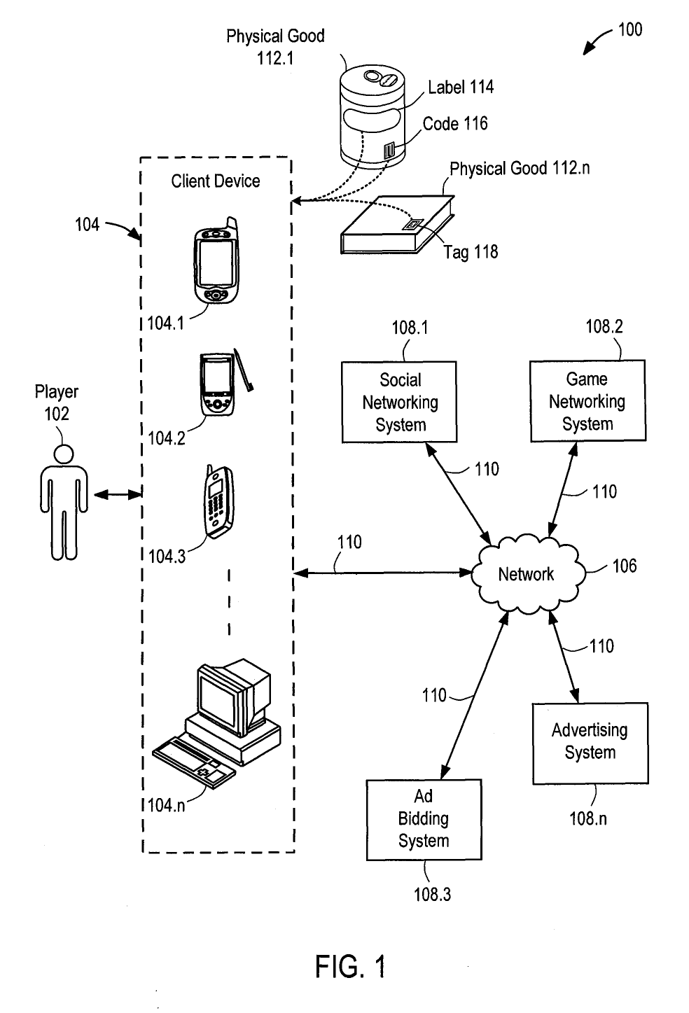

FIG. 1 illustrates an example of a system 100 for implementing various example embodiments. In some embodiments, the system 100 comprises a player 102, a client device 104, a network 106, a social networking system 108.1, a game networking system 108.2, an ad bidding system 108.3, and one or more advertising systems (e.g., an advertising system 108.n). The components of the system 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 104 may be any suitable computing device (e.g., devices 104.1-104.n), such as a smart phone 104.1, a personal digital assistant (PDA) 104.2, a mobile phone 104.3, a personal computer 104.n, a laptop, a computing tablet, and the like. The client device 104 may access the social networking system 108.1 or the game networking system 108.2 directly, via the network 106, or via a third-party system. For example, the client device 104 may access the game networking system 108.2 via the social networking system 108.1. The client device 104 may be any suitable computing device, such as a personal computer, laptop, cellular phone, smart phone, computing tablet, and the like. The player 102 can use the client device 104 to scan a label 114 or a code 116 (e.g., a bar code), or to read a radio frequency identification (RFID) tag 118, of a physical good (e.g., physical goods 112.1-112.n). Moreover, the client device 104 can inform the ad bidding system 108.3 or the advertising system 108.n that the player 102 has scanned one or more of the physical goods 112.1-112.n.

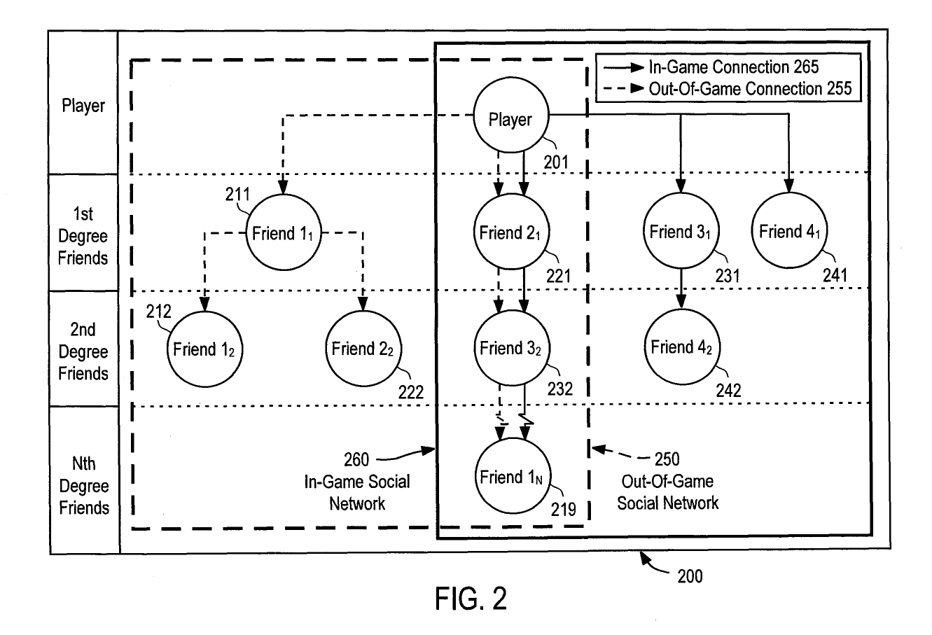

The social networking system 108.1 may include a network-addressable computing system that can host one or more social graphs (see, for example, FIG. 2), and may be accessed by the other components of system 100 either directly or via the network 106. The social networking system 108.1 may generate, store, receive, and transmit social networking data. Moreover, the game networking system 108.2 may include a network-addressable computing system (or systems) that can host one or more virtual games, for example, online. The game networking system 108.2 may generate, store, receive, and transmit game-related data, such as, for example, game account data, game input, game state data, and game displays. The game networking system 108.2 may be accessed by the other components of system 100 either directly or via the network 106. The player 102 may use the client device 104 to access, send data to, and receive data from the social networking system 108.1 and/or the game networking system 108.2. In various example embodiments, the game networking system 108.2 may include an introduction mechanic that can introduce player 102 to other players of the game networking system 108.2 who are encountering a common in-game obstacle.

The ad bidding system 108.3 may be a network-addressable computing system that can host automated auctions for advertising opportunities within the virtual game. The advertising system 108.n may include a network-addressable computing system that can submit advertising offers to the ad bidding system 108.3. The ad bidding system 108.3 and the advertising system 108.n may be accessed by the other components of system 100 either directly or via the network 106.

Although FIG. 1 illustrates a particular example of the arrangement of the player 102, the client device 104, the social networking system 108.1, the game networking system 108.2, and the network 106, this disclosure includes any suitable arrangement or configuration of the player 102, the client device 104, the social networking system 108.1, the game networking system 108.2, the ad bidding system 108.3, the advertising system 108.n, and the network 106.

FIG. 2 shows an example of a social network within a social graph 200. Social graph 200 is shown by way of example to include an out-of-game social network 250 and an in-game social network 260. Moreover, in-game social network 260 may include one or more players who are friends with Player 201 (e.g., Friend 231), and may include one or more other players who are not friends with the Player 201. The social graph 200 may correspond to the various players associated with the virtual game. In an example embodiment, each player may “build” their own virtual structures using branded virtual objects and/or unbranded virtual objects. When, for example, the Player 201 visits the virtual environment of the Friend 231, the virtual environment displayed to the Player 201 includes branded objects selected and placed in that environment by the Friend 231.

### Automated Bidding System

In some embodiments, the ad bidding system 108.3 facilitates processing offers from one or more advertising entities for an advertising opportunity within the virtual game. The advertising opportunities may be processed live/in real-time. In an example embodiment, and the advertising opportunities may be for advertsing slots in a virtual game.

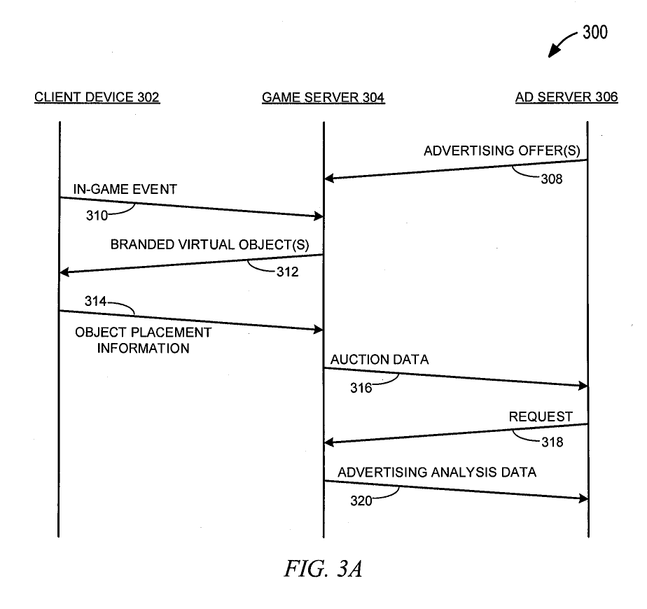

FIG. 3A shows a diagram illustrating example communication messages 300 between example components of an example system. Communication messages 300 may be performed using one or more of the components of the example system 100 of FIG. 1 and, accordingly, are described by way of example with reference thereto. For example, a client device 302 may correspond to a computing device 104, a game server 304 may correspond to a game networking system 108.2 and/or ad bidding system 108.3, and an ad server 306 may correspond to an advertising system 108.n.

In some example embodiments, the ad server 306 may send one or more advertising offers 308 to the game server 304, at which point the game server considers these advertising offers to satisfy an advertising opportunity. Moreover, a client device 302 may send an in-game event 310 (e.g., a player of client device 302 chooses to build a virtual diner within a personal virtual city of the computer-implemented game) to the game server 304, which may cause game server 304 to create an advertising opportunity (e.g., an opportunity to present the player with one or more branded virtual diners to place in his personal virtual city of the computer-implemented game). The game server 304 may, for example, select and send a set of one or more branded virtual objects 312 to the client device 302, and the client device 302 may present the player with an in-game menu that allows the player to select a branded virtual object (e.g., a virtual diner) to place in his personal virtual environment.

In some example embodiments, when the player selects a branded virtual object to place within his personal virtual environment, the client device 302 may send object placement information 314 to the game server 304, which may cause the game server 304 to complete a bid auction for the advertising opportunity. In some embodiments, the game server 304 may send auction data 316 that indicates the winning bid to the ad server 306 that won the bid auction. Moreover, the ad server 306 may send a request 318 to the game server 304 for advertising analysis data pertaining to one or more advertising offers, and the game server 304 may send analysis data 320 to the ad server 306.

FIG. 3B shows a flowchart illustrating an example method 330 to accept an advertising offer within the virtual game. In an example embodiment, advertising offers are made and accepted while the game is in progress or being played. In some embodiments, the method 330 may be performed using the ad bidding system 108.3 and may perform communication messages 300, and, accordingly, is described by way of example with reference thereto. The method 330 may begin, at operation 332, by receiving an advertising offer from an advertising entity (e.g., an advertising offer 308 pertaining to a clothing brand) for an advertising opportunity (e.g., an in-game billboard). In various embodiments, the advertising offer may include attributes that indicate a branded virtual good (e.g., Heinz™ ketchup), a branded in-game asset (e.g., a stove within a virtual café), a branded virtual structure (e.g., a McDonald's™ diner), a branded decorative item (e.g., a statue of a football player wearing a 49ers™ jersey), a branded in-game object (e.g., a Chevrolet™ Corvette sports car), or the like (hereinafter collectively referred to as a branded virtual object). In other embodiments, the advertising offer may include offer attributes that indicate a physical good (e.g., an article of clothing) or a service (e.g., a dry-cleaning service).

Next, at operation 334, the method 330 may determine opportunity constraints of the advertising opportunity. For example, the method 330 may determine that the advertising opportunity has an inventory constraint indicating a number of available in-game displays for the advertisement. Moreover, the method 330 may determine that the advertising opportunity also has entity constraints, which are applicable to an advertiser from which the advertising offer is received. These entity constraints may indicate, for example, minimum and maximum dimensions for the in-game display, and a list of restricted image content categories. For example the minimum and maximum dimensions may be those of a virtual structure such as a building in the virtual game.

The method 330 may then selectively accept the advertising offer at operation 336 using an automated process without human intervention, and may present a branded virtual object of the advertising offer to a player (e.g., may send branded virtual objects 312 to client device 302) at operation 338. The player of the client device 104 may be one of many active participants currently playing the virtual game. At operation 340, the method 330 may generate advertising analysis data based on advertising events associated with the player (e.g., the player may perform actions that satisfy certain marketing objectives of the advertiser). The analysis data may include at least one of the unique identifier for the physical good or service, a scan frequency for the physical good or service, a purchase frequency for the physical good or service, a purchase repetition period for the physical good or service, context information associated with scans of the physical good or service, context information associated with purchases of the physical good or service, or the like.

In various example embodiments, during operation 340, the method 330 may track how the player interacts with the advertising offer (e.g., using the client device 302). For example, the method 330 may determine that the player has purchased a branded virtual object within the virtual game or has clicked on an advertisement corresponding to a branded object placement. Moreover, the method 330 may determine that the player has solicited or purchased a physical good or service associated with an advertising offer after being presented with the branded virtual object within the virtual game. Thus, in an example embodiment, advertising opportunities are facilitated during the playing of an virtual game and are based on the user actions of a participating player. In an example embodiment, the advertising opportunity may be complex in nature comprising a potential sequence (or stack) of advertising opportunities (e.g., advertisements, incentives, coupons, or the like). For example, when a player interacts with a first advertising opportunity a subsequent advertising opportunity may then be presented to the player. If the player interacts with the subsequent advertising opportunity, a further advertising opportunity may be presented, and so on. In an example embodiment, a virtual object may change state each time a player interacts with the virtual object (e.g., clicks on the virtual object). Prospective advertisers may bid on each advertising opportunity (or advertising opportunities) in a sequence of advertising opportunities. However, it is to be appreciated that an advertiser may also bid on several or all of the advertising opportunities in the sequence or stack. Thus, in example embodiments, an advertiser may control the visual life cycle of a virtual object (e.g., a branded virtual object) or group of virtual objects.

One or more of the advertising opportunities may be player specific. For example, a player specific advertising opportunity may include a follow-on player specific code (e.g., a redemption code, incentive code, or the like). The player specific code may, for example, be printed on a receipt when purchasing a physical and/or virtual goods or services. For example, assuming that the advertising opportunity (or one of the advertising opportunities in a sequence of advertising opportunities) relates to the purchase of Heinz™ ketchup, then the follow-on player specific code, coupon or any other benefit may be provided on the receipt (e.g., on a physical receipt or electronic receipt). The player may then use this code to redeem further value (e.g., a discount on further purchases (virtual or otherwise)).

FIG. 3C shows a flowchart illustrating an example method 350 to process an advertising offer within the virtual game. In an example embodiment, advertising offers are made and accepted while the game is in progress or being played. In some embodiments, the method 350 may be performed using the ad bidding system 108.3 and may perform communication messages 300, and, accordingly, is described by way of example with reference thereto. The method 350 may begin, at operation 352, by receiving advertising offers from multiple entities for an advertising opportunity (e.g., the advertising offers 308 from the ad server 306). In various embodiments, the advertising offer may include attributes that indicate a branded virtual object. In other embodiments, the advertising offer may include offer attributes that indicate a physical good or service.

Next, the method 350 may determine opportunity constraints (e.g., a number of menu positions available within an in-game menu for displaying a certain virtual object category) of the advertising opportunity at operation 354. Then, at operation 356, the method 350 may select a subset of the advertising offers based on these advertising constraints. For example, method 350 may select five advertising offers for branded virtual objects that are most related to a fast food diner category and that indicate a highest bid amount. The method 350 may then present branded virtual objects for these advertising offers to a player at operation 358 (e.g., by sending the branded virtual objects 312 to the client device 302 for display to the player). At operation 360, the method 350 may accept an advertising offer for a branded virtual object that is selected by the player, thereby including the player in the bid-selection process. For example, the method 350 may present the player with multiple branded virtual objects (e.g., these objects may correspond to multiple advertising offers) within an in-game menu, and may charge an advertising fee to an advertiser for an advertising offer when the player selects a corresponding branded virtual object from the menu.

At operation 362, the method 350 provides a branded virtual object associated with the advertising offer to the player (e.g., branded virtual objects 312), thereby allowing the player to place this branded virtual object within a virtual world for other players to see (e.g., in a graphical user interface (GUI) displayed on a participating client device 104). For example, the advertiser may customize the look and/or interactive features of the branded virtual object so that it appeals to many players of a particular demographic. Therefore, players that like this branded virtual object may decide to place it at a highly-visible location of the virtual world, or near other highly-regarded virtual objects. Moreover, as the player interacts with the branded virtual object, the player may perform actions associated with advertising events that may result in additional advertising charges to the advertiser.

At operation 364, the method 350 may generate advertising analysis data (e.g., analysis data 320) based on advertising events associated with the player. During operation 364, the method 350 may track how the player interacts with the advertising offer. For example, the method 350 may determine that the player has interacted with a branded virtual object within the virtual game. Moreover, the method 350 may determine that the player has selected (e.g., solicited or purchased) a physical good or service associated with an advertising offer after being presented with the corresponding branded virtual object within the virtual game.

### Advertising Opportunities

In some example embodiments, an advertising opportunity may include an in-game display, or may include a branded product placement within the virtual game. Accordingly, the branded product may be provided in a GUI presented to a player participating in the game. For example, an apparel company may submit a bid to display an image on a virtual billboard or poster of the virtual game. As a second example, a car manufacturer may submit a bid to cause a particular car model to drive through a virtual city of the virtual game. In various other embodiments, an advertising opportunity may include a menu position within an in-game menu for displaying a branded virtual object that a player can purchase and place within his personal virtual environment of the virtual game. In various exmaple embodiments, the advertising opportunity may include a menu position within an in-game menu for displaying a branded virtual object, a placement position within the virtual environment for displaying a branded virtual object, a digital coupon redeemable against a price of a physical good or a service, an incentive to purchase a physical good or a service, an advert for a physical good or a service, and a pop-up offer that is presented to a user of the computer-implemented game, or the like.

In some example embodiments, an offer attribute may indicate at least one of: a unique identifier for the physical good or service; a market restriction that indicates a set of physical venues at which a digital coupon is not to be presented to the player (e.g., via a mobile computing device while the player is visiting the physical venue); a game state of the virtual game at which the digital coupon is to be presented to the player; a coupon price for the physical good or service of the digital coupon; and the like. An offer attribute may also indicate at least one of a bid price for an advertising event associated with a player of the virtual game; a bid price for an incentive that is offered to the player to encourage the player to perform an action associated with an advertising event; and the like.

In various example embodiments, an advertising offer may be associated with a group incentive. Offer attributes for this advertising offer may indicate a minimum number of players that need to purchase a branded virtual object, a physical good, or a service before the incentive is distributed. The offer attributes may also indicate a social relationship required between two players in the minimum number of players, a game state associated with a player in the minimum number of players, and/or a minimum level of in-game social interaction from the minimum number of players. For example, these offer attributes may indicate that the incentive is to be provided to a group of at least two close friends that are highly active in the virtual game. The example social graph 200 (see FIG. 2) may be used to identify a relationship between two or more players.

In some embodiments, an opportunity constraint may include an inventory constraint of the advertising opportunity, and/or an entity constraint applicable to the advertiser from which the advertising offer is received. An inventory constraint may include: a number of available in-game displays; a number of menu positions available within an in-game menu to display branded virtual objects; a number of pop-up views available to present offers to players of the virtual game; and/or the like.

In some embodiments, an entity constraint may be imposed by the methods 330 and 350 onto the advertiser from which the advertising offer is received. An entity constraint may include a visual constraint that restricts the placement and/or dimensions for images and virtual objects, and may include a content constraint that restricts the nature of the content being displayed. For example, a visual constraint may include an available menu position within an in-game menu within a GUI of the virtual game, and may include a minimum and/or maximum dimension for an in-game display or for a skinning image. Moreover, a content constraint for a branded object being injected into the virtual game may include: a virtual object category, a restriction to certain types of decorative objects, a list of restricted image content categories, a list of restricted words, a list of restricted brand names, a list of restricted products, and/or the like. Virtual object categories may include, for example, a virtual diner, a public building, a business asset (e.g., a stove), a decorative item, or the like.

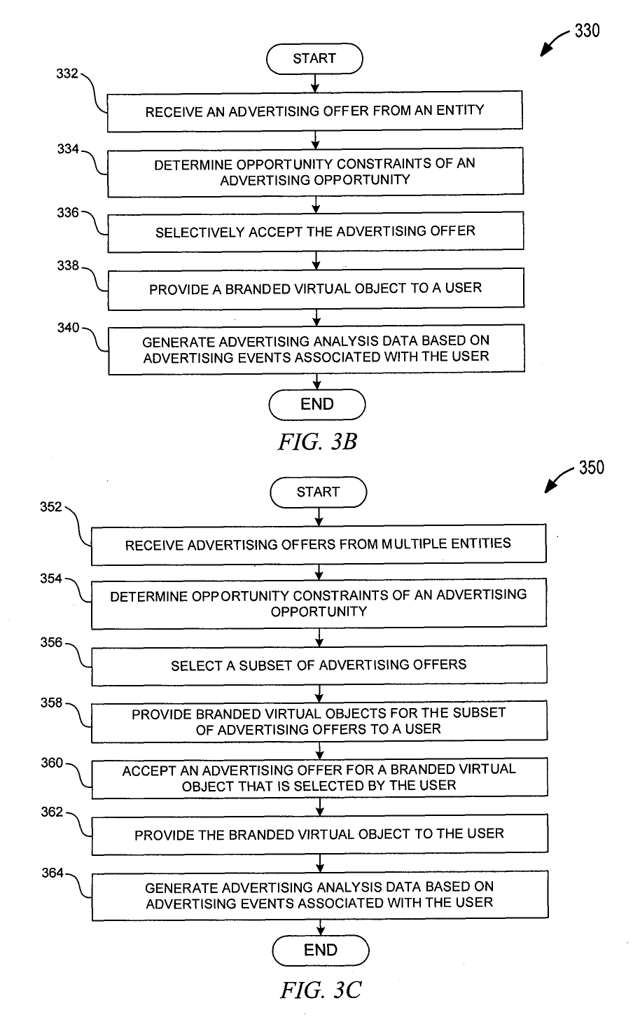

FIG. 4 shows an example user interface 400 for displaying a player's virtual environment 401 on a display screen. In some embodiments, the user interface 400 may be provided to the client device 104 by the game networking system 108.2, and may be displayed to the player by the client device 104. For example, the user interface 400 may provide the player with a virtual café that allows the player to cooperate and/or compete with other players while achieving in-game objectives. In the example virtual game illustrated in FIG. 4, the user interface 400 shows the virtual café and various components or virtual structures of this café, and the player may interact with various components of this café(e.g., the stove asset 402) to complete game objectives and, for example, earn virtual currency.

In various example embodiments, the player may click on (or otherwise activate) various aspects of the game interface to provide instructions to the virtual game. For example, by clicking on the stove asset 402, the player may virtually prepare meals that are served to guests of the virtual café to collect virtual coins or currency. Moreover, the player's in-game character may possess a certain level of in-game character energy, and may expend a determinable amount of character energy when interacting with a virtual object to complete an in-game job (e.g., preparing a cake may expend more character energy than preparing a hamburger). The player may also click on various icons in user interface 400 to activate various game options. For example, the player may cause the virtual game to display an in-game menu (e.g., an in-game menu 420) that presents options for buying and selling in-game objects for use in the virtual environment. These in-game objects include but are not limited to virtual objects, virtual goods, virtual furniture, virtual appliances, décor, or the like.

In various embodiments, the in-game menu 420 may include a set of menu positions that display branded virtual objects (e.g., branded virtual good 426) to players. For example, the method 330 or 350 may create an advertising opportunity that includes a subset of menu positions (e.g., empty position 430) from the menu 420, thereby making these menu positions available for bids from multiple entities. Once an advertising offer from the advertiser (e.g., advertising system 108.n) has won a bid for a menu position (e.g., position 424), the method 330 or 350 may remove this menu position from the inventory constraint of the advertising opportunity.

In various embodiments, the method 330 or 350 may allocate a subset of the menu positions to display an unbranded virtual object, and may not include these menu positions in the inventory constraint for an advertising opportunity. Moreover, the method 330 or 350 may charge a higher bid amount for branded virtual objects that are placed farther away from these unbranded virtual objects than it does for those that are placed closer to the unbranded virtual objects.

In some embodiments, an advertising opportunity may include a pop-up offer that may be presented to a player, a coupon that may be redeemable against the price of a virtual object, or a digital incentive that may offer a virtual object to the player. For example, the advertiser may place an advertising offer that bids for a pop-up offer, and may use this pop-up offer to provide a player with a digital coupon that is redeemable against the price of a virtual object.

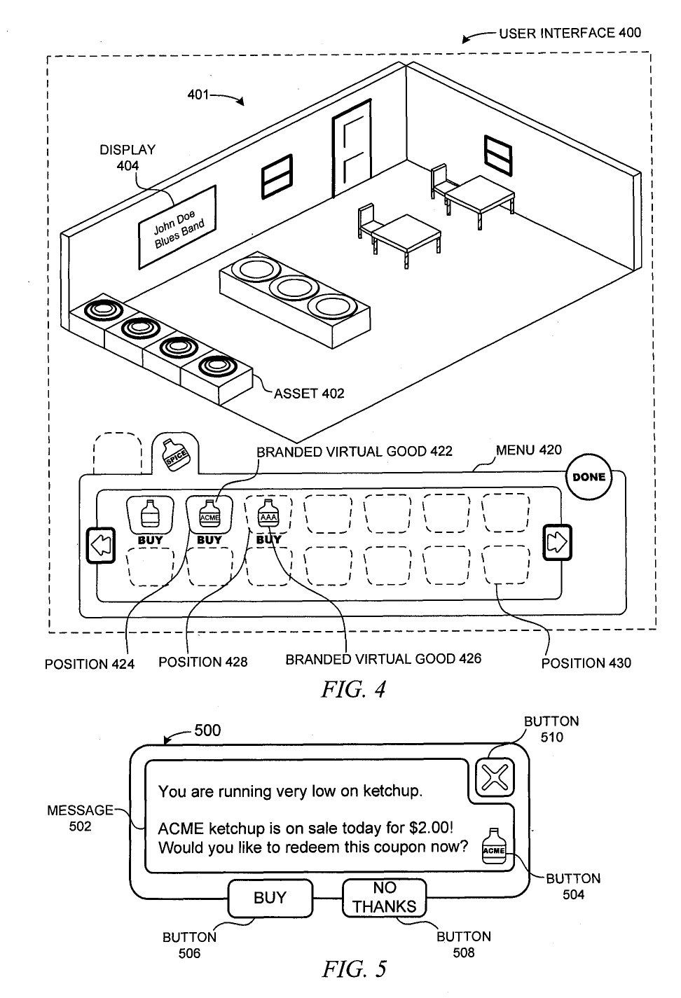

FIG. 5 shows an example pop-up display 500 that presents an offer to a player of the virtual game. In some embodiments, the pop-up display 500 may be provided to the client device 104 by the game networking system 108.2, and may be presented to the player by the client device 104. For example, the game networking system 108.2 may provide the pop-up display 500 to the client device 104 to present the player 102 with an advertising offer that has placed a winning bid.

Display 500 may include a message 502 that informs the player about the details of the offer, and may include one or more buttons for interacting with display 500. For example, the display 500 may provide the player with a digital coupon, and the message 502 may inform the player that the digital coupon may be redeemable against the price of a virtual object. Also, a button 504 may cause the method 330 or 350 to provide the player with additional information about the branded virtual object or about a corresponding physical good. The player may use a button 506 to redeem the offer, or may use a button 508 to reject the offer. In various embodiments, a button 510 may allow the player to dismiss the offer without redeeming or rejecting the offer, thereby allowing a system performing the method 330 or 350 to present the offer to the player at a later time.

In some embodiments, the branded virtual object may include an object that is customized by the advertiser from which the advertising offer is received. Also, the branded virtual object may include a virtual representation for a branded consumer product or service, such as a store or restaurant, clothing apparel, a food item, an automobile, and the like. For example, the player may purchase a McDonald's™ diner to place within a virtual city of the virtual game, or may customize an avatar so that it wears distinguishable clothing that has been designed by Guess™ jeans.

In various embodiments, the advertiser may customize an unbranded virtual object to create a branded virtual object. For example, offer attributes for the branded virtual object may indicate a skinning image that is to be displayed over at least a portion of the unbranded virtual object, or may indicate a set of images that illustrate the branded virtual object facing different directions.

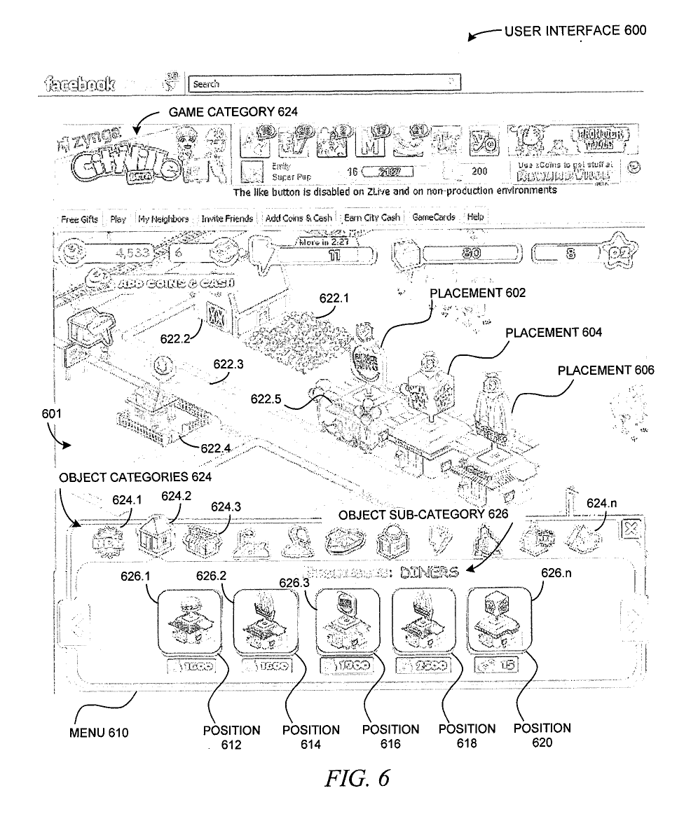

FIG. 6 shows an example user interface 600 displaying a player's virtual environment 601 on a display screen. In some embodiments, the user interface 600 may be provided to the client device 104 by the game networking system 108.2, and displayed to the player by the client device 104. For example, the user interface 600 may provide the player with a virtual city that allows the player to cooperate and/or compete with other players while achieving in-game objectives. The user interface 600 may include a number of branded virtual objects placed at particular locations of the virtual city (e.g., placements 602, 604, and 606), and may include an in-game menu 610 that may be used by the player to purchase virtual objects.

In various example embodiments, the player may purchase virtual objects to improve the virtual city by placing these virtual objects within the virtual environment 601. For example, the player may place (e.g., using a pointing device such as a mouse, a touch screen, or the like) a farm plot object 622.1 in the virtual environment 601 to grow a crop, and may place a barn object 622.2 in the virtual environment 601 to store goods. The player may place a road 622.3 that spans across a portion of the virtual environment 601 for in-game characters to travel on, and may place a house 622.4 next to a portion of the road 622.3. The player may also place branded or unbranded businesses (e.g., a branded diner 622.5) next to the road 622.3, which allows the diner 622.5 to serve residents of the house 622.4. The player may collect rent from the house 622.4 at determinable time intervals, and may collect coins from the diner 622.5 after a determinable number of guests have been served. In an example embodiment, the game networking system 108.2 may receive, from a user of the computer-implemented game, a placement position for placing the branded virtual object in the virtual environment. Thereafter, the game networking system 108.2 may modify it's data repository to reflect that the user has placed the branded virtual object at the placement position in the virtual environment.

In some example embodiments, placing additional houses in virtual environment 601 increases the population of the player's virtual city, which in turn may increase the rate at which a placed business serves guests, thereby increasing the rate at which the player may collect coins. Also, adding friends as neighbors (e.g., a friend 221 of the in-game social network 260 of FIG. 2) allows friends to send a tour bus to the player's virtual city, which may travel on road 622.3 to visit a placed business (e.g., the diner 622.5) in the player's virtual environment 601. The tour bus may then view the branded virtual businesses in the virtual environment 601.

In some example embodiments, “placing” the virtual object may be performed by the player selecting an object from the in-game menu 610 (e.g., the object 626.3 at menu position 616 of menu 610), at which point a game engine for the virtual game (e.g., an application executed by the client device 104 and/or the game networking system 108.2) may place the selected object at an initial placement position of the virtual environment 601. The user may then drag the virtual object from the initial placement position to a desired placement position of the virtual environment 601 (e.g., a placement position 602). In other example embodiments, placing the virtual object may be performed by the player dragging the virtual object from the menu 610 to the desired placement position (e.g., dragging object 626.3 from the menu position 616 to the placement position 602).

In some example embodiments, “selecting” the virtual object may be performed by the player using a pointing device (e.g., a mouse or a touch pad) to click on the virtual object (e.g., using the left mouse button). Moreover, “dragging” the object may be performed by the player using the pointing device to click on the virtual object, and drag the virtual object to a different display position while the mouse button is being held down. In other example embodiments, for a player using a touch screen (e.g., a resistive touch screen or a capacitive touch screen), “selecting” the virtual object may be performed by the player tapping (e.g., using a finger or a stylus) on a portion of the touch screen that is displaying the virtual object. Moreover, “dragging” the virtual object may be performed by the player placing a finger on a portion of the touch screen that displays the virtual object (e.g., the menu position 616), and dragging the finger across a portion of the touch screen that displays the virtual environment 601 to place the virtual object (e.g., the branded virtual object 622) at a different placement position (e.g., the placement position 602) of the virtual environment 601.

In various example embodiments, the in-game menu 610 may include a set of menu positions that display unbranded or branded virtual objects to players. Also, the ad bidding system 108.3 may account for the menu positions that are to display branded virtual objects (e.g., positions 614, 616, 618, and 620) in the inventory constraint for an advertising opportunity, thereby making these menu positions available for bids from multiple advertising entities (e.g., the advertising system 108.n).

In some embodiments, the system 100 may reserve a subset of the menu positions to display an unbranded virtual object (e.g., position 612), and may not include these menu positions in the inventory constraint for an advertising opportunity. For example, the in-game menu 610 includes five menu positions for displaying virtual objects that the player may buy, but only the last four menu positions (e.g., positions 614, 616, 618, and 620) are available for displaying a branded virtual object.

In various embodiments, the example system, executing the example methods described herein, may charge a higher bid amount for branded virtual objects that are placed farther away from these unbranded virtual objects than it does for those that are placed closer to the unbranded virtual objects. Moreover, the virtual price (e.g., the amount of virtual currency needed for a player to buy a virtual object) may be higher for branded virtual objects that are placed farther from unbranded virtual objects, thereby resulting in a higher perceived value for these virtual objects. Thus, the advertiser may find it beneficial to submit advertising offers with a highest possible bid so that their branded virtual objects, and thus their brand name, is attributed the highest perceived value within the virtual game. In an example embodiment, the number of branded virtual objects available to an advertiser may be limited or restricted by the inventory constraint. In addition or instead, the entity constraint may define or regulate placement positions of the branded virtual objects within the virtual environment.

### Example Selection of an Offer

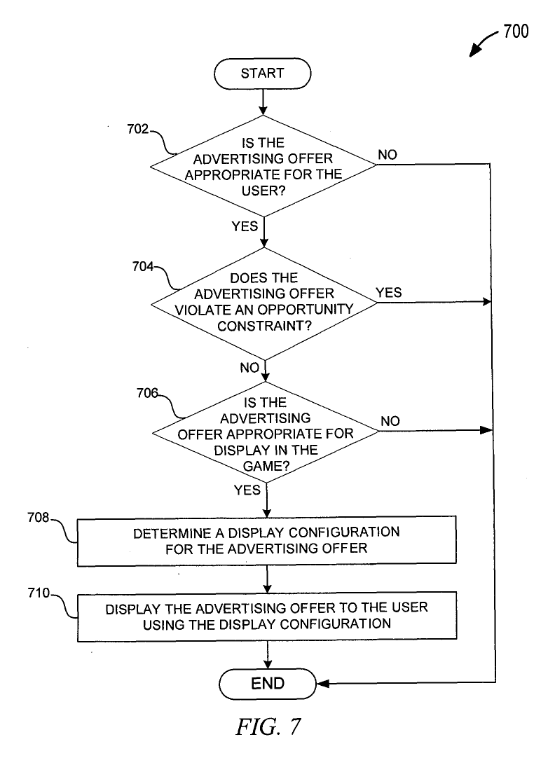

FIG. 7 shows a flowchart illustrating an example method 700 to display an acceptable advertising offer to the player of the virtual game. It should be noted that the advertising offer may be auctioned in an advertising market place to a plurality of advertisers. In some embodiments, method 700 may be performed using the game networking system 108.2 and, accordingly, is described by way of example with reference thereto. The method 700 may begin, at operation 702, by determining whether an advertising offer is appropriate for a player. For example, during operation 702, the method 700 may determine whether the player is an ideal target audience for the advertising offer based on one or more of: a game state associated with the player; demographic information for the player; an expected redemption value of the incentive; or the like.

One or more databases in the gaming networking system 108.2 may include the data types set out below to, inter alia, determine an appropriate target audience. The data types may, for example, relate to players of a virtual game (e.g., an online virtual game) and be processed in real-time to enhance the identification of a plurality of target players. The data types include social network data, user-generated content data, in-game objects data, in-game obstacles data, game diversity data, actions precedent (ACP) to a user-generated event data, demographic data, location data, localization data, traversal of known websites data, level of engagement data, lifetime value data that indicates a time duration that a player has been a member of a game network, and the like.

The social network data may include the size of a player's social network, a width of the player's social network, the depth of player's social network, networks with which the player is affiliated (and, optionally, all metadata available from these networks), the player's choice of friends/associated players, the player's reputation within a social network (optionally including intrinsic and extrinsic data related to a real-life social graph and active social network), and/or the like. The reputation-related data for the player may be based on user-generated content (UGC) from the player or his N^{th} degree friends (e.g., in-game messages or social network messages).

The user-generated content data may include one-on-one communications (e.g., chat messages, instant messages, emails, etc.), public messages, Facebook™ wall posts, and/or the like.

The in-game objects data may include objects (e.g., virtual objects purchased in a virtual game) that are owned or used by a player, and/or trades (e.g., of virtual objects) or commercial aspects related to a player (e.g., objects desired by a player (e.g., wish lists), objects not being used by player (e.g., objects that are a good candidate for gift or trade), objects given or received as a gift, objects given or received during a trade, or the like).

The in-game obstacles data may include current or completed obstacles (e.g., challenges presented to a player to advance to a higher level in a game).

The game diversity data may include types of games (e.g., types of games a player chooses to play, statistical distribution for how much a player plays each type of game, or the like), and/or a pattern of play (e.g., a play pattern across multiple games), character temperament during game play, anthropological measure (e.g., likes violent games, tendency toward violent games, etc.).

The actions precedent (ACP) data may include various player actions and include multi-dimensional (1 to n) characteristics. The dimensions include, health, attack, observe, comment, or the like associated with the players and/or player objects. The actions precedent (ACP) may also include events (e.g., invitations, gift, purchase, another action, etc.) and/or semantic weighting (e.g., of UGC) of the ACP (e.g., understanding the meaning and tone of the words and phrases in UGC that result in a given event), or the like.

Weighted semantic indicators may be provided that the game networking system may use to interpret the UGC. A semantic indicator may correspond to a word or phrase used in the UGC, and may include a weighted value that indicates a likelihood for a certain meaning and/or tone (e.g., a likelihood that the player's use of the word “bad” in the UGC may be interpreted as “good”). In some example embodiments, the game networking system 108.2 may use the weighted semantic indicators to satisfy a trigger description of a trigger event. For example, the game networking system 108.2 may use the semantic indicators to analyze UGC, and based on the semantic indicators that match the UGC with a high likelihood, the game networking system 108.2 may determine one or more possible trigger events that indicate in-game events that the player is likely to perform (and determine likelihood values related thereto).

The data type may further include location data such as a physical location (e.g., a current location and/or previously visited locations) and travel data. The travel data may identify movement of the player in the real-world. For example, for players at different commercial location, for example, Starbucks™ locations, the players' locations can be collapsed into a single meta-Starbucks data type based on a common location attribute (e.g., player at a Starbucks™). Players at a common location may be grouped based on this meta-location (e.g., Starbucks™ franchise) and, for example, these players can be introduced to each other. In an example embodiment, an offer may be made to these players based on their shared meta-location (e.g., a Starbucks™ offer may be presented). The data type may also be demographic data. In some example embodiments, the location data may be user-provided player information that is gathered from the player, his client device, or an affiliate social network. The user-provided player information may include the player's demographic information, the player's location information (e.g., a historical record of the player's location during game play as determined via a GPS-enabled device or the internet protocol (IP) address for the player's client device), the player's localization information (e.g., a list of languages chosen by the player), the types of games played by the player, and the like.

The data type may also include language data. For example, user may then be able to elect to play games in other languages/localizations, regardless of their current geographic location. The data type may also include data identifying traversal of known websites (e.g., Meebo web platform and/or any other website check-in approaches). The data type may also include characteristics of sites typically visited by a player.

In example embodiments, the data type may include data on a level of engagement by a player. For example the data on a frequency of play (e.g., for a particular game or and plurality of online games), timing of actions and/or responses from players in an online game, a likelihood to monetize an opportunity presented to a player (e.g, identify a class of players that can monetize at a given rate/within the next T time period if certain conditions are met (e.g., players are offered/provided with a particular offer object), game context under which a player is likely to monetize, players that are likely to monetize under a given context, or the like).

The player's likelihood to lead may, optionally, be based on information about the player's interactions with others and the outcome of these interactions. For example, the game networking system 108.2 may determine the player's likelihood to lead value by measuring the player's amount of interaction with other players (e.g., as measured by a number of challenges that the player cooperates with others, and/or an elapsed time duration related thereto), the player's amount of communication with other players, the tone of the communication sent or received by the player, and/or the like. Moreover, the game networking system 108.2 may determine the player's likelihood to lead value based on determining a likelihood for the other players to perform a certain action in response to interacting or communicating with the player. For example, the game networking system 108.2 may determine the player's likelihood to lead value based on measurements for a number of purchases (and, optionally, the purchase value) that other players perform after interacting with the player (e.g., a purchase of a virtual good, or from a flash sale transaction).

In some example embodiments, the player's level of engagement may include a likelihood value indicating a likelihood that the player may perform a desired action. For example, the player's level of engagement may indicate a likelihood that the player may purchase a virtual object from the virtual game, may purchase an item from a flash sale transaction in the virtual game, or may complete a new in-game challenge within a determinable period of time from when it is first presented to him.

Data may also identify or provide a measure of a likelihood for players in social network to crystallize around an individual with a high degree of engagement/communication or monetization. Accordingly, the data may include derived player information that indicates the player's level of engagement, the player's friend preferences, the player's reputation, the player's pattern of game-play, and the like. For example, the player's friend preferences may be determined based on player attributes that his/her first-degree friends have in common, and may store these player attributes as friend preferences in a player profile. In some example embodiments, the player's level of engagement may be indicated from the player's performance within the virtual game.

The data type may also show a lifetime value that a player has to game network (e.g., duration and level of participation in the past) and, thus, a prediction of how much this player will contribute to the game network system 108.2. Example metrics to measure the lifetime value may include how much monetization can be expected from the player, how many user engagements this player initiates with other players, how many times other players initiate an engagement with this player, or the like.

In some example embodiments, the game networking system 108.2 may determine possible triggers and likelihood values for a certain in-game event by analyzing the player game state and the player profile when the player performs an in-game event. The game networking system 108.2 may then generate or update one or more event triggers for this event based on these possible triggers for the player's event. For example, when the player performs a particular event (or does not perform the event) as the player continues to play the virtual game, the game networking system 108.2 may update likelihood values for event triggers that are specific to this player, thus improving the accuracy of the event triggers to predict when the player may perform this in-game event.

Returning to operation 702, if the advertisement is not appropriate for the user, the method 700 may not accept the advertising offer. Otherwise, if the method 700 determines that the advertising offer is appropriate for the player, the method 700 continues to operation 704.

At operation 704, the method 700 determines whether the advertising offer violates an opportunity constraint of the advertising opportunity. If so, the method 700 may not accept the advertising offer. Otherwise, if the method 700 determines that the advertising offer does not violate an opportunity constraint, the method 700 continues to operation 706.

At operation 706, the method 700 determines whether the advertising offer is appropriate for the virtual game. If method 700 determines at operation 706 that the advertising offer is not appropriate for the virtual game, the method 700 may not accept the advertising offer. Otherwise, the method 700 may continue to operation 708.

In various embodiments, at operation 706, the method 700 may determine that the advertising offer is appropriate for the virtual game based on one or more of: an inventory constraint; metadata that describes the virtual game; a unique identifier for the physical good or service associated with the advertising offer; or the like. For example, at operation 706, the method 700 may determine that an advertising offer is appropriate for the virtual game by first determining classification data (e.g., a product category, a brand name, etc.) for the physical good or service, and determining that the inventory constraint indicates an available inventory for an advertising offer associated with this classification data.

In various embodiments, the method 700 may obtain classification data or descriptive data using a universal purchase code (UPC) for the physical good, and may determine whether the advertising offer is appropriate for display based on the product description. Operation 706 may also involve determining whether this classification data is in-line with a game theme or marketing strategy indicated by the metadata. For example, the method 700 may reject an advertising offer associated with cigarettes in response to determining that the classification data (e.g., tobacco products) is currently banned by a marketing strategy indicated by the game metadata.

Next, at operation 708, the method 700 may determine a display configuration for the advertising offer. In various embodiments, the method 700 may prefer a first advertising offer over a second advertising offer based on determining that the dimensions for an image of the first advertising offer are a better match to the advertising opportunity than the dimensions for an image of the second advertising offer. For example, the dimensions of an advertising opportunity may correspond to an available real estate in a virtual landscape of the computer-implemented game. As another example, the dimensions of an advertising opportunity may correspond to dimensions of an in-game display.

Then, at operation 710, the method 700 may display the advertising offer to the player using the display configuration. In various embodiments, operations 702, 704, and 706 may be performed in a different sequence than what is illustrated in FIG. 7. For example, the method 700 may determine whether an advertising offer is appropriate for display in the game (e.g., operation 706) before determining whether the advertising offer is appropriate for the player (e.g., operation 702) and/or before determining whether the advertising offer violates an opportunity constraint (e.g., operation 704). In example embodiments, the method may determine that the advertising offer is appropriate for a user of the computer-implemented game based on a game state associated with the user, demographic information for the user, or an expected redemption value of an incentive that is offered to the user. Further, the method may determine that the advertising offer is appropriate for the computer-implemented game based on an inventory constraint, metadata that describes the computer-implemented game, a unique identifier for the physical good or service, or the like. The advertising offer from the advertising entity may be selected when the advertising offer does not violate an opportunity constraint of the advertising opportunity.

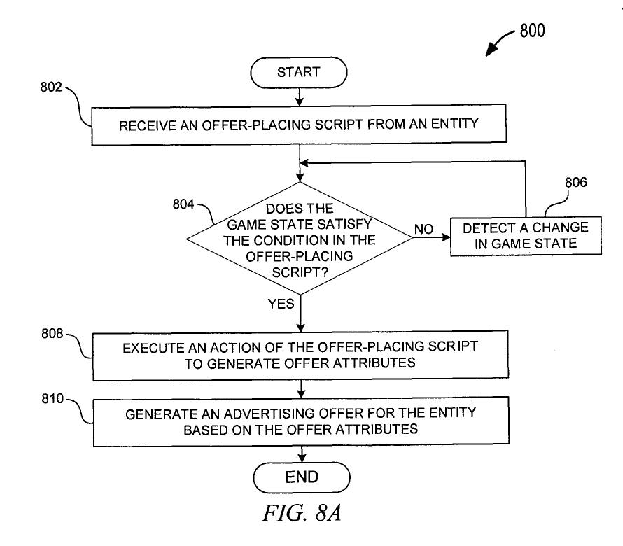

FIG. 8A shows a flowchart illustrating an example method 800 to generate an advertising offer using an offer-placing script. In some embodiments, method 800 may be performed using the ad bidding system 108.3 and, accordingly, is described by way of example with reference thereto. The offer-placing script may include a condition indicating when to generate the advertising offer, and may include an action to perform to generate the advertising offer. The method 800 may begin, at operation 802, by receiving an offer-placing script from the advertiser (e.g., Burger King™). Then, at operation 804, the method 800 determines whether the game state satisfies a condition in the offer-placing script. If not, the method 800 may wait, at operation 806, until it detects a change in game state, at which point it may return to operation 804. Otherwise, if the method 800 determines that the game state satisfies a condition of the script, the method 800 may continue to operation 808. Example game states include, but are not limited to one or more of the following: a player commencing to a determinable game level; the player's avatar stepping over a trigger position of a virtual landscape of the virtual game; the player completing a quest; the player failing to complete a quest within a determinable time period; or the like.

At operation 808, the method 800 may execute an action of the offer-placing script to generate offer attributes (e.g., offer attributes that indicate a maximum bid amount, image data for a branded virtual object, classification data for the branded virtual object, and the like). In some embodiments, the offer attributes indicate at least one of a number of users required to purchase the physical good or service before the incentive is distributed, an expiration date for the incentive, an on-line relationship required between two users in the required number of users, a game state associated with a user in the required number of users, and a minimum level of in-game social interaction from the required number of users.

Then, at operation 810, the method 800 may generate an advertising offer for the advertiser based on these offer attributes. For example, an offer-placing script from Burger King™ may include a condition that is triggered when the player's virtual city includes a competing diner (e.g., a McDonald's™ diner). Also, the action of the offer-placing script may cause the method 800 to generate an advertising offer for placing a virtual object that displays a Burger King™ billboard in the virtual city. Furthermore, the action of the offer-placing script may generate a high bid for the advertising offer if the competing diner is placed at a prominent placement position of the virtual city.

FIG. 8B shows a flowchart illustrating an example method 850 to update an advertising offer using an offer-updating script. In some embodiments, method 850 may be performed using the ad bidding system 108.3 and, accordingly, is described by way of example with reference thereto. The offer-updating script may include a condition indicating when to generate new offer attributes for the advertising offer, and may include an action to perform (e.g., compute a new bid amount) in order to generate these offer attributes. In various embodiments, an offer-placing script may also be used as an offer-updating script. The method 850 may begin, at operation 852, by receiving an offer-updating script from the advertiser. Then, at operation 854, the method 850 determines whether the game state satisfies a condition in the offer-updating script. If not, the method 850 may wait, at operation 856, until it detects a change in game state, at which point it may return to operation 854. Otherwise, if the method 850 determines that the game state satisfies a condition of the script, the method 850 may continue to operation 858.

At operation 858, the method 850 may execute an action of the offer-updating script to generate new offer attributes for a corresponding advertising offer. Then, at operation 860, the method 850 may update the advertising offer based on these new offer attributes. For example, an offer-updating script from Burger King™ may include a condition that is triggered when the player moves a competing diner (e.g., a McDonald's™ diner) to a new placement position of the virtual city. Also, the action of the offer-updating script may cause the method 850 to generate new offer attributes with a higher bid when the competing diner is moved to a more prominent placement position of the virtual city, or may generate new offer attributes with a lower bid when the competing diner is removed or is moved to a less prominent placement position. Accordingly, bidding values may be dependent upon the particular placement position of a virtual object in a virtual game.

### Tracking Example Advertising Events

In some example embodiments, the ad bidding system 108.3 may track how the player interacts with an advertisement or an advertising product. For example, the ad bidding system 108.3 may monitor an impression count for an advertisement within an virtual game, and may track advertising events that indicate how the player interacts with in-game objects associated with this advertisement. Moreover, the ad bidding system 108.3 may also track out-of-game advertising events that indicate how the player interacts with physical goods or services associated with the advertising offer. For example, the player may configure a personal computing device to provide advertising event updates to the ad bidding system 108.3.

In some example embodiments, an advertising event may include receiving a confirmation that the player has visited a physical location associated with a digital coupon, such as by receiving location information from the player's client device (e.g., receiving a geo-tagged check-in notification), or by the player signing into a computing device stationed at the physical location. In various example embodiments, a merchant may provide a digital incentive to the player while the player is participating in the on-line game, such that the digital incentive offers a virtual object to the player, and the digital incentive becomes redeemed when the player physically visits one of the merchant's stores. Then, when the player enters the merchant's store, the player may use a global positioning system (GPS)-enabled mobile device to provide the ad bidding system 108.3 with location information indicating that the player is at a physical location associated with the digital incentive (e.g., provides an absolute location of the physical store, or provides a location identifier indicating the store's name).

Another advertising event may include receiving a confirmation that the player has scanned a code that is attached to a physical good or that is provided by the advertiser associated with a service (e.g., a merchant). For example, the virtual game may provide a digital incentive to the player on behalf of the merchant while the player is participating with the on-line game, such that the digital incentive offers a virtual object to the player. Moreover, the digital incentive may become redeemed when the player uses a personal mobile device to scan a physical good associated with the merchant. The player may use a mobile device (e.g., client device 104) to take a picture of the label 114 or the code 116 of the physical good 112.1, or to read the RFID tag 118 that is attached to the physical good 112.n.

Other advertising events may include receiving a confirmation that the player has purchased the physical good or service, displaying a point-of-sale (POS) message to the player in response to the player purchasing the physical good or service, sending a follow-up message to the player in response to the player performing an action associated with an advertising event, and/or the like.

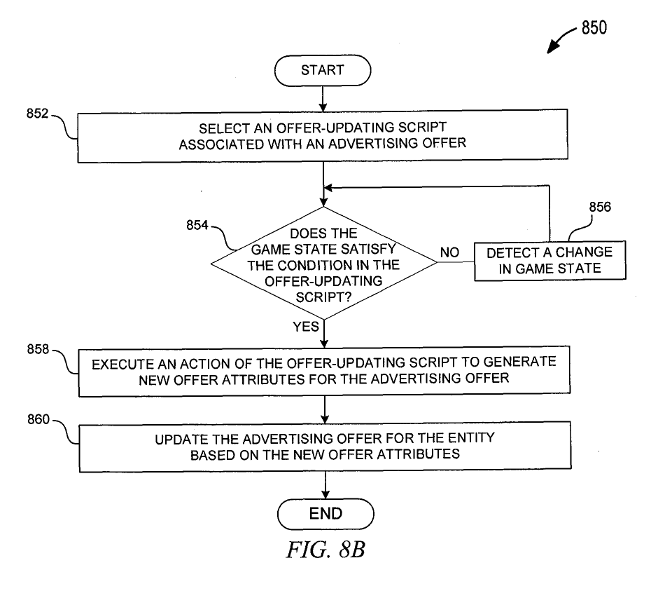

FIG. 9 shows a flowchart illustrating an example method 900 to process advertising events associated with the player of the virtual game. In some embodiments, method 900 may be performed using ad bidding system 108.3 and, accordingly, is described by way of example with reference thereto. The method 900 may begin, at operation 902, by receiving a scan confirmation from the player. For example, the player may scan a physical good using a personal mobile device to redeem a digital incentive or to receive additional information about the physical good. Then, the method 900 may continue to operation 910.

In various embodiments, the method 900 may also begin, at operation 904, by receiving a purchase confirmation from a merchant. At operation 906, the method 900 may determine whether a POS message is to be displayed to the player. For example, if the player has made a purchase at a merchant's store, the method 900 may decide to provide the player with a personal message at the POS device that may remind the player of other incentivized offers. If the method 900 determines that a POS message is to be displayed to the player, the method 900 may continue to operation 908 to display the POS message to the player, and then may continue to operation 910. Otherwise, the method 900 may proceed to operation 910 from operation 906.

At operation 910, the method 900 may determine whether to send a follow-up message to the player. For example, a merchant may wish to provide the player with a personal message or other offers when the player scans a particular physical good. If the method 900 determines that the follow-up message is to be sent to the player, the method 900 may continue to operation 912 to send this follow-up message to the player. Otherwise, the method 900 may proceed to operation 914 from operation 910.

At operation 914, the method 900 may process any advertising events associated with the player. At operation 916, the method 900 may use these advertising events to generate advertising analysis data.

In various embodiments, the follow-up message may be an electronic-mail message, or may be a message provided to the player via a computer-implemented social network. Moreover, the follow-up message may include an incentive to encourage the player to perform an action that further interacts with the physical good or service (e.g., perform an action that leads to a further advertising event), or to consider other physical goods. For example, an incentive may include a virtual object, virtual currency, character energy, and/or the like. In various example embodiments, the system may provide the player with a branded virtual object version of the physical good in response to an advertising event associated with the physical good (e.g., the player has purchased the physical good).

In some embodiments, the method 900 may generate advertising analysis data based on advertising events associated with players of the virtual game. For example, the advertising analysis data may include at least one of: a unique identifier for a physical good or service; a scan frequency for the physical good or service; a purchase frequency for the physical good or service; a purchase repetition period for the physical good or service; context information associated with scans of the physical good or service; context information associated with purchases of the physical good or service; or the like.

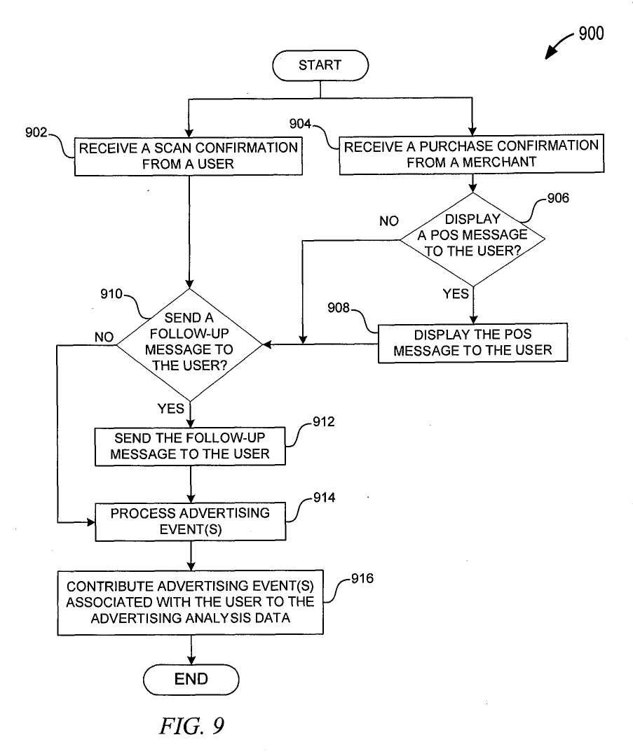

FIG. 10 illustrates an example apparatus, in accordance with various example embodiments. Apparatus 1000 may include a storage module 1002, an interface module 1004, an offer-processing module 1006, and an analysis module 1008.

In particular embodiments, modules 1002-1008 may be implemented using one or more application-specific integrated circuit components, microprocessors, graphics processing units (GPUs), field-programmable gate arrays (FPGAs), or any combination thereof. In other embodiments, apparatus 1000 may include a server-side computing device and/or a client side computing device, and modules 1002-1008 may include executable code that is stored within a computer-readable storage medium of apparatus 1000 and executed by a processing unit of apparatus 1000.

The storage module 1002 may store opportunity constraints for a plurality of advertising opportunities, and may store a plurality of advertising offers received from advertising entities. An advertising opportunity may indicate an opportunity to place a branded virtual object in a virtual environment of the virtual game. For example, the advertising opportunities may indicate placement opportunities in a virtual city of the virtual game, and an advertising offer may include a description for a McDonald's™ diner as a branded virtual object to place in the virtual city.

In various example embodiments, the storage module 1002 may include a database configured to process a search query for an advertising opportunity, or to process a search query for an advertising offer. For example, the search query may indicate at least one opportunity constraint associated with an advertising opportunity, and the storage module 1002 may perform a search to generate search results that include advertising offers that satisfy the indicated opportunity constraints of the advertising opportunity.

The interface module 1004 may generate GUIs and/or text-based user interfaces to interact with the player. For example, the interface module 1004 may generate user interfaces 400, 500, and 600 to present to the player, such that these user interfaces included branded virtual objects placed within a virtual environment of the virtual game. In various examples, these user interfaces may include a web page implemented using a combination of scripting technologies such as: Hypertext Markup Language (HTML), JavaScript, Cascading Style Sheet (CSS), ActionScript, or the like.

In some example embodiments, the interface module 1004 may include a web application programming interface (API) that may allow advertising entities to interact with apparatus 1000 using a Hypertext Transfer Protocol (HTTP) session. For example, the advertiser may use the web API to receive information about an advertising opportunity to place a branded virtual object in a virtual environment of the virtual game. The interface module 1004 may also receive an advertising offer for the advertising opportunity from the advertiser via the web API, and may use the storage module 1002 to store the advertising offer. This advertising offer may include offer attributes that indicate at least a virtual object to place in the virtual environment.

The offer-processing module 1006 may selectively accept an advertising offer (e.g., using an automated process without human intervention) based on the opportunity constraints of an advertising opportunity, and may cause the interface module 1004 to provide a virtual object of the advertising offer to a client device for inclusion in the virtual environment of the virtual game. In some example embodiments, the offer-processing module 1006 may generate a search query for an advertising offer based on the opportunity constraints of the advertising opportunity, and may process the search query using the storage module 1002 to obtain search results that include at least one advertising offer. The offer-processing module 1006 may analyze the advertising offers in the search results to select a valid advertising offer. For example, the offer-processing module 1006 may analyze an advertizing offer to determine whether offer attributes of this advertising offer violate the opportunity constraints of the advertising opportunity. The offer-processing module 1006 may accept an advertising offer from the search results if the offer attributes of this advertising offer do not violate the opportunity constraints of the advertising opportunity.

The analysis module 1008 may generate analysis data based on advertising events associated with a set of players of the virtual game. For example, the analysis module 1008 may track how players interact with a physical good or service being advertised, and may generate analysis data that includes at least one of: a unique identifier for the physical good or service being advertised; a scan frequency at which players scan a tag associated with the physical good or service; a purchase frequency for the physical good or service; a purchase repetition period for the physical good or service; context information associated with scans of the physical good or service; or the like.

### Example Game Systems, Social Networks, and Social Graphs

In an online multiplayer game, players control player characters (PCs), a game engine controls non-player characters (NPCs), and the game engine also manages player character state and tracks state for currently active (e.g., online) players and currently inactive (e.g., offline) players. A player character may have a set of attributes and a set of friends associated with the player character. As used herein, the terms “state” and “attributes” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a player (or a group of more than one players), the game engine may take into account the state of the player character (or group of PCs) that is playing, but also the state of one or more PCs of offline/inactive players who are connected to the current player (or PC, or group of PCs) through the game social graph but are not necessarily involved in the game at the time.

For example, Player A with six friends on his team (e.g., the friends that are listed as being in the player's mob/gang/set/army/business/crew/etc. depending on the nature of the game) may be playing the online game and choose to confront Player B who has 20 friends on her team. In some embodiments, a player may only have first-degree friends on his or her team. In other embodiments, a player may also have second-degree and higher degree friends on his or her team. To resolve the game event, in some embodiments the game engine may total up the weapon strength of the seven members of Player A's team and the weapon strength of the 21 members of Player B's team and decide an outcome of the confrontation based on a random variable applied to a probability distribution that favors the side with the greater total. In some embodiments, all of this may be done without any other current active participants other than Player A (e.g., Player A's friends, Player, B, and Player B's friends could all be offline or inactive). In some embodiments, the friends in a player's team may see a change in their state as part of the outcome of the game event. In some embodiments, the state (assets, condition, level) of friends beyond the first degree are taken into account.

### Example Game Networking Systems

An online game may be hosted by the game networking system 108.2, which can be accessed using any suitable connection 110 with a suitable client device 104. A player may have a game account on the game networking system 108.2, wherein the game account may contain a variety of information associated with the player (e.g., the player's personal information, financial information, purchase history, player character state, game state, etc.). In some embodiments, a player may play multiple games on the game networking system 108.2, which may maintain a single game account for the player with respect to the multiple games, or multiple individual game accounts for each game with respect to the player. In some embodiments, the game networking system 108.2 may assign a unique identifier to a player 102 of an online game hosted on the game networking system 108.2. The game networking system 108.2 may determine that the player 102 is accessing the online game by reading the player's cookies, which may be appended to HTTP requests transmitted by the client device 104, and/or by the player 102 logging onto the online game.

In some embodiments, the player 102 may access an online game and control the game's progress via the client device 104 (e.g., by inputting commands to the game at the client device). The client device 104 can display the game interface, receive inputs from the player 102, transmit user inputs or other events to the game engine, and receive instructions from the game engine. The game engine can be executed on any suitable system (such as, for example, the client device 104, the social networking system 108.1, or the game networking system 108.2). For example, the client device 104 may download client components of an online game, which are executed locally, while a remote game server, such as the game networking system 108.2, provides backend support for the client components and may be responsible for maintaining application data of the game, processing the inputs from the player, updating and/or synchronizing the game state based on the game logic and each input from the player, and transmitting instructions to the client device 104. As another example, when the player 102 provides an input to the game through the client device 104 (such as, for example, by typing on the keyboard or clicking the mouse of the client device 104), the client components of the game may transmit the player's input to the game networking system 108.2.

In some embodiments, the player 102 may access particular game instances of an online game. A game instance is a copy of a specific game play area that is created during runtime. In some embodiments, a game instance is a discrete game play area where one or more players 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific players. A game instance is associated with a specific player when one or more game parameters of the game instance are associated with the specific player. For example, a game instance associated with a first player may be named “First Player's Play Area.” This game instance may be populated with the first player's PC and one or more in-game objects associated with the first player.

In some embodiments, a game instance associated with a specific player may only be accessible by that specific player. For example, a first player may access a first game instance when playing an online game, and this first game instance may be inaccessible to all other players. In other embodiments, a game instance associated with a specific player may be accessible by one or more other players, either synchronously or asynchronously with the specific player's game play. For example, a first player may be associated with a first game instance, but the first game instance may be accessed by all first-degree friends in the first player's social network.

In some embodiments, the set of in-game actions available to a specific player may be different in a game instance that is associated with this player compared to a game instance that is not associated with this player. The set of in-game actions available to a specific player in a game instance associated with this player may be a subset, superset, or independent of the set of in-game actions available to this player in a game instance that is not associated with him. For example, a first player may be associated with Blackacre Farm in an online farming game, and may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

In some embodiments, a game engine may interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a player or player character in an online multiplayer game.

In some embodiments, the social graph is managed by the game networking system 108.2, which is managed by the game operator. In other embodiments, the social graph is part of a social networking system 108.1 managed by a third-party (e.g., Facebook, Friendster, Myspace). In yet other embodiments, the player 102 has a social network on both the game networking system 108.2 and the social networking system 108.1, wherein the player 102 can have a social network on the game networking system 108.2 that is a subset, superset, or independent of the player's social network on the social networking system 108.1. In such combined systems, game network system 108.2 can maintain social graph information with edge type attributes that indicate whether a given friend is an “in-game friend,” an “out-of-game friend,” or both. The various embodiments disclosed herein are operable when the social graph is managed by the social networking system 108.1, the game networking system 108.2, or both.

### Example Systems and Methods

Returning to FIG. 2, the Player 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to the Player 201. As used herein, the terms “player” and “user” can be used interchangeably and can refer to any user in an online multiuser game system or social networking system. As used herein, the term “friend” can mean any node within a player's social network.

As shown in FIG. 2, the Player 201 has direct connections with several friends. When the Player 201 has a direct connection with another individual, that connection is referred to as a first-degree friend. In out-of-game social network 250, the Player 201 has two first-degree friends. That is, the Player 201 is directly connected to Friend 1₁ 211 and Friend 2₁ 221. In social graph 200, it is possible for individuals to be connected to other individuals through their first-degree friends (e.g., friends of friends). As described above, the number of edges in a minimum path that connects a player to another user is considered the degree of separation. For example, FIG. 2 shows that the Player 201 has three second-degree friends to which he is connected via his connection to his first-degree friends. Second-degree Friend 1₂ 212 and Friend 2₂ 222 are connected to the Player 201 via his first-degree Friend 1₁ 211. The limit on the depth of friend connections, or the number of degrees of separation for associations, that the Player 201 is allowed is typically dictated by the restrictions and policies implemented by the social networking system 108.1.

In various embodiments, the Player 201 can have Nth-degree friends connected to him through a chain of intermediary degree friends as indicated in FIG. 2. For example, Nth-degree Friend 1_{N} 219 is connected to the Player 201 within in-game social network 260 via second-degree Friend 3₂ 232 and one or more other higher-degree friends.

In some embodiments, a player (or player character) may have a social graph within an online multiplayer game that is maintained by the game engine and another social graph maintained by a separate social networking system. FIG. 2 depicts an example of in-game social network 260 and out-of-game social network 250. In this example, the Player 201 has out-of-game connections 255 to a plurality of friends, forming out-of-game social network 250. Here, Friend 1₁ 211 and Friend 2₁ 221 are first-degree friends with the Player 201 in his out-of-game social network 250. The Player 201 also has in-game connections 265 to a plurality of players, forming in-game social network 260. Here, Friend 2₁ 221, Friend 3₁ 231, and Friend 4₁ 241 are first-degree friends with the Player 201 in his in-game social network 260. In some embodiments, a game engine can access in-game social network 260, out-of-game social network 250, or both.

In some embodiments, the connections in a player's in-game social network can be formed both explicitly (e.g., when users “friend” each other) and implicitly (e.g., when the system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (e.g., in disintermediated interactions or the like), but that could be the case.

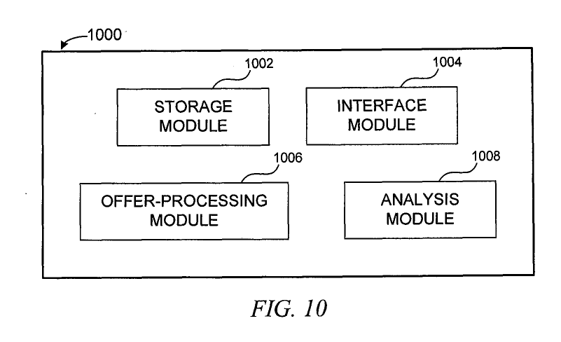

FIG. 11 illustrates an example data flow between example components of an example system 1100. One or more of the components of the example system 1100 may correspond to one or more of the components of the example system 100. In some embodiments, system 1100 can include client system 1130, social networking system 1120a, and game networking system 1120b. The components of system 1100 can be connected to each other in any suitable configuration, using any suitable type of connection. The components may be connected directly or over any suitable network. Client system 1130, social networking system 1120a, and game networking system 1120b may have one or more corresponding data stores such as local data store 1125, social data store 1145, and game data store 1165, respectively.

Social networking system 1120a and game networking system 1120b may also have at least one server that may communicate with client system 1130 over an appropriate network. Social networking system 1120a and game networking system 1120b may have, for example, one or more internet servers for communicating with client system 1130 via the Internet. Similarly, social networking system 1120a and game networking system 1120b may have one or more mobile servers for communicating with client system 1130 via a mobile network (e.g., GSM, PCS, Wi-Fi, WPAN, etc.). In some embodiments, one server may be able to communicate with client system 1130 over both the Internet and a mobile network. In other embodiments, separate servers can be used.

Client system 1130 may receive and transmit data 1123 to and from game networking system 1120b. This data can include, for example, a web page, a message, a game input, a game display, a HTTP packet, a data request, transaction information, and other suitable data. At some other time, or at the same time, game networking system 1120b may communicate data 1143, 1147 (e.g., game state information, game system account information, page info, messages, data requests, updates, etc.) with other networking systems, such as social networking system 1120a (e.g., Facebook, Myspace, etc.). Client system 1130 can also receive and transmit data 1127 to and from social networking system 1120a. This data can include, for example, web pages, messages, social graph information, social network displays, HTTP packets, data requests, transaction information, updates, and other suitable data.

Communication between client system 1130, social networking system 1120a, and game networking system 1120b can occur over any appropriate electronic communication medium or network using any suitable communications protocols. For example, client system 1130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. In some embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In some embodiments, a client request may cause a server to respond with a first data object, such as an HTML page, which itself refers to other data objects. A client application, such as a browser, will request these additional data objects as it parses or otherwise processes the first data object.

In some embodiments, an instance of an online game can be stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a player accesses an online game on game networking system 1120b, the BLOB containing the game state for the instance corresponding to the player may be transmitted to client system 1130 for use by a client-side executed object to process. In some embodiments, the client-side executable may be a FLASH-based game, which can de-serialize the game state data in the BLOB. As a player plays the game, the game logic implemented at client system 1130 maintains and modifies the various game state parameters locally. The client-side game logic may also batch game events, such as mouse clicks, and transmit these events to game networking system 1120b. Game networking system 1120b may itself operate by retrieving a copy of the BLOB from a database or an intermediate memory cache (memcache) layer. Game networking system 1120b can also de-serialize the BLOB to resolve the game state parameters and execute its own game logic based on the events in the batch file of events transmitted by the client to synchronize the game state on the server side. Game networking system 1120b may then re-serialize the game state, now modified into a BLOB, and pass this to a memory cache layer for lazy updates to a persistent database.

In some embodiments, a computer-implemented game may be a text-based or turn-based game implemented as a series of web pages that are generated after a player selects one or more actions to perform. The web pages may be displayed in a browser client executed on client system 1130. For example, a client application downloaded to client system 1130 may operate to serve a set of web pages to a player. As another example, a computer-implemented game may be an animated or rendered game executable as a stand-alone application or within the context of a webpage or other structured document. In some embodiments, the computer-implemented game may be implemented using Adobe Flash-based technologies. As an example, a game may be fully or partially implemented as a SWF object that is embedded in a web page and executable by a Flash media player plug-in. In some embodiments, one or more described web pages may be associated with or accessed by social networking system 1120a. This disclosure contemplates using any suitable application for the retrieval and rendering of structured documents hosted by any suitable network-addressable resource or website.

Application event data of a game is any data relevant to the game (e.g., player inputs). In some embodiments, each application datum may have a name and a value, and the value of the application datum may change (e.g., be updated) at any time. When an update to an application datum occurs at client system 1130, either caused by an action of a game player or by the game logic itself, client system 1130 may need to inform game networking system 1120b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies.

In some embodiments, one or more objects of a game may be represented as an Adobe Flash object. Flash may manipulate vector and raster graphics, and supports bidirectional streaming of audio and video. “Flash” may mean the authoring environment, the player, or the application files. In some embodiments, client system 1130 may include a Flash client. The Flash client may be configured to receive and run Flash application or game object code from any suitable networking system (such as, for example, social networking system 1120a or game networking system 1120b). In some embodiments, the Flash client may be run in a browser client executed on client system 1130. A player can interact with Flash objects using client system 1130 and the Flash client. The Flash objects can represent a variety of in-game objects. Thus, the player may perform various in-game actions on various in-game objects by making various changes and updates to the associated Flash objects.

In some embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In some embodiments, when the player makes a change to a Flash object representing an in-game object, the client-executed game logic may update one or more game state parameters associated with the in-game object. To ensure synchronization between the Flash object shown to the player at client system 1130, the Flash client may send the events that caused the game state changes to the in-game object to game networking system 1120b. However, to expedite the processing and hence the speed of the overall gaming experience, the Flash client may collect a batch of some number of events or updates into a batch file. The number of events or updates may be determined by the Flash client dynamically or determined by game networking system 1120b based on server loads or other factors. For example, client system 1130 may send a batch file to game networking system 1120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In some embodiments, each application datum may have a name and a value. The value of an application datum may change at any time in response to the game play of a player or in response to the game engine (e.g., based on the game logic). In some embodiments, an application data update occurs when the value of a specific application datum is changed.

In some embodiments, when a player plays an online game on client system 1130, game networking system 1120b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In some embodiments, while a player is not playing the online game, the corresponding BLOB may be stored in the database. This enables a player to stop playing the game at any time without losing the current state of the game the player is in. When a player resumes playing the game next time, game networking system 1120b may retrieve the corresponding BLOB from the database to determine the most-recent values of the game-related data. In some embodiments, while a player is playing the online game, game networking system 1120b may also load the corresponding BLOB into a memory cache so that the game system may have faster access to the BLOB and the game-related data contained therein.

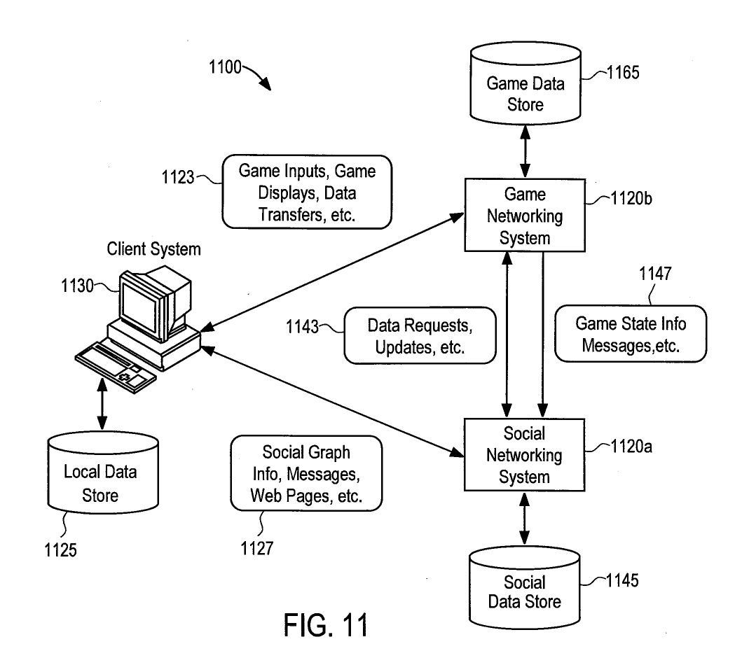

Various embodiments may operate in a wide area network environment, such as the Internet, including multiple network addressable systems. FIG. 12 illustrates an example network environment 1200, in which various example embodiments may operate. Network cloud 1260 generally represents one or more interconnected networks, over which the systems and hosts described herein can communicate. Network cloud 1260 may include packet-based wide area networks (such as the Internet), private networks, wireless networks, satellite networks, cellular networks, paging networks, and the like. As FIG. 12 illustrates, various embodiments may operate in a network environment 1200 comprising one or more networking systems, such as social networking system 1220a, game networking system 1220b, and one or more client systems 1230. The components of social networking system 1220a and game networking system 1220b operate analogously; as such, hereinafter they may be referred to simply as networking system 1220. Client systems 1230 are operably connected to the network environment 1200 via a network service provider, a wireless carrier, or any other suitable means.

Networking system 1220 is a network addressable system that, in various example embodiments, comprises one or more physical servers 1222 and data stores 1224. The one or more physical servers 1222 are operably connected to computer network cloud 1260 via, by way of example, a set of routers and/or networking switches 1226. In an example embodiment, the functionality hosted by the one or more physical servers 1222 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

Physical servers 1222 may host functionality directed to the operations of networking system 1220. Hereinafter servers 1222 may be referred to as server 1222, although server 1222 may include numerous servers hosting, for example, networking system 1220, as well as other content distribution servers, data stores, and databases. Data store 1224 may store content and data relating to, and enabling, operation of, networking system 1220 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc.

Logically, data store 1224 corresponds to one or more of a variety of separate and integrated databases, such as relational databases and object-oriented databases, that maintain information as an integrated collection of logically related records or files stored on one or more physical systems. Structurally, data store 1224 may generally include one or more of a large class of data storage and management systems. In some embodiments, data store 1224 may be implemented by any suitable physical system(s) including components, such as one or more database servers, mass storage media, media library systems, storage area networks, data storage clouds, and the like. In one example embodiment, data store 1224 includes one or more servers, databases (e.g., MySQL), and/or data warehouses. Data store 1224 may include data associated with different networking system 1220 users and/or client systems 1230.

Client system 1230 is generally a computer or computing device including functionality for communicating (e.g., remotely) over a computer network. Client system 1230 may be a desktop computer, laptop computer, personal digital assistant (PDA), in- or out-of-car navigation system, smart phone or other cellular or mobile phone, or mobile gaming device, among other suitable computing devices. Client system 1230 may execute one or more client applications, such as a Web browser.

When a user at a client system 1230 desires to view a particular webpage (hereinafter also referred to as target structured document) hosted by networking system 1220, the user's web browser, or other document rendering engine or suitable client application, formulates and transmits a request to networking system 1220. The request generally includes a URL or other document identifier as well as metadata or other information. By way of example, the request may include information identifying the user, a timestamp identifying when the request was transmitted, and/or location information identifying a geographic location of the user's client system 1230 or a logical network location of the user's client system 1230.

Although the example network environment 1200 described above and illustrated in FIG. 12 is described with respect to social networking system 1220a and game networking system 1220b, this disclosure encompasses any suitable network environment using any suitable systems. For example, the network environment may include online media systems, online reviewing systems, online search engines, online advertising systems, or any combination of two or more such systems.

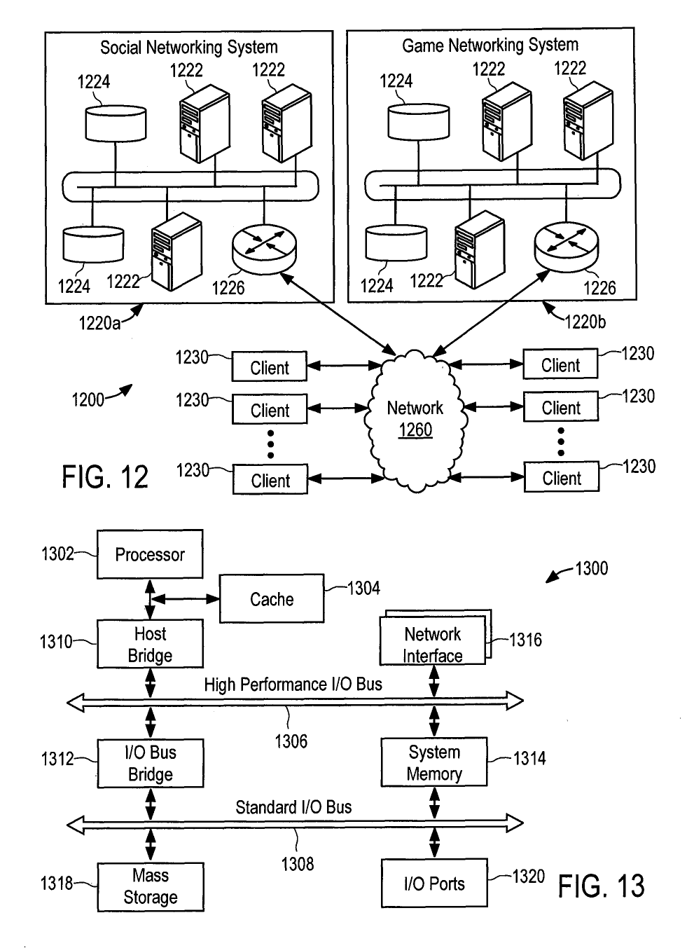

FIG. 13 illustrates an example computing system architecture, which may be used to implement a server 1222 or a client system 1230. In one embodiment, hardware system 1300 comprises a processor 1302, a cache memory 1304, and one or more executable modules and drivers, stored on a tangible computer readable medium, directed to the functions described herein. Additionally, hardware system 1300 may include a high performance input/output (I/O) bus 1306 and a standard I/O bus 1308. A host bridge 1310 may couple processor 1302 to high performance I/O bus 1306, whereas I/O bus bridge 1312 couples the two buses 1306 and 1308 to each other. A system memory 1314 and one or more network/communication interfaces 1316 may couple to bus 1306. Hardware system 1300 may further include video memory (not shown) and a display device coupled to the video memory. Mass storage 1318 and I/O ports 1320 may couple to bus 1308. Hardware system 1300 may optionally include a keyboard, a pointing device, and a display device (not shown) coupled to bus 1308. Collectively, these elements are intended to represent a broad category of computer hardware systems.

The elements of hardware system 1300 are described in greater detail below. In particular, network interface 1316 provides communication between hardware system 1300 and any of a wide range of networks, such as an Ethernet (e.g., IEEE 802.3) network, a backplane, etc. Mass storage 1318 provides permanent storage for the data and programming instructions to perform the above-described functions implemented in servers 1222 of FIG. 12, whereas system memory 1314 (e.g., DRAM) provides temporary storage for the data and programming instructions when executed by processor 1302. I/O ports 1320 are one or more serial and/or parallel communication ports that provide communication between additional peripheral devices, which may be coupled to hardware system 1300.

Hardware system 1300 may include a variety of system architectures and various components of hardware system 1300 may be rearranged. For example, cache memory 1304 may be on-chip with processor 1302. Alternatively, cache memory 1304 and processor 1302 may be packed together as a “processor module,” with processor 1302 being referred to as the “processor core.” Furthermore, certain embodiments of the present disclosure may neither require nor include all of the above components. For example, the peripheral devices shown coupled to standard I/O bus 1308 may couple to high performance I/O bus 1306. In addition, in some embodiments, only a single bus may exist, with the components of hardware system 1300 being coupled to the single bus. Furthermore, hardware system 1300 may include additional components, such as additional processors, storage devices, or memories.

An operating system manages and controls the operation of hardware system 1300, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, PDA, personal gaming device, etc.), that makes API calls directly to a server. Still further, while the embodiments described above operate with business-related virtual objects (such as stores and restaurants), the embodiments may be applied to any in-game asset around which a harvest mechanic may be implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

1. A computerized method for processing offers for an advertising opportunity in one of a plurality of computer-implemented games, the method comprising:
receiving, from an advertising entity via a network, an advertising offer for the advertising opportunity, the advertising opportunity indicating an opportunity to place a virtual object in a virtual environment of a computer-implemented game of the plurality of computer-implemented games, and the advertising offer including offer attributes that indicate at least the virtual object for the advertising opportunity and the computer-implemented game;
determining opportunity constraints of the advertising opportunity;
automatically using at least one processor, accepting the advertising offer from the advertising entity based on the offer attribute indicating the computer implemented game and the opportunity constraints; and
including the virtual object of the advertising offer in the virtual environment of the computer-implemented game.

2. The method of claim 1, wherein the including of the virtual object in the virtual environment comprises:
receiving, from a user of the computer-implemented game, a placement position for placing the virtual object in the virtual environment; and
placing the virtual object at the placement position of the virtual environment.

3. The method of claim 1, wherein the opportunity constraints include at least one of:
an inventory constraint of the advertising opportunity; and
an entity constraint applicable to an entity from which an offer is received.

4. The method of claim 1, wherein the opportunity constraints include an inventory constraint including at least one of:
a number of advertising opportunities available for displaying a branded virtual object within an in-game market;
a number of advertising opportunities available for displaying a branded virtual object within the virtual environment;
a number of branded virtual objects available to an advertiser; and
a number of pop-up views available to present offers to users of the computer-implemented game.

5. The method of claim 1, wherein the opportunity constraints includes an entity constraint including at least one of:
a virtual object category;
a minimum dimension for a virtual object or image;
a maximum dimension for a virtual object or image;
a list of restricted image content categories;
a list of menu positions within an in-game menu at which a branded virtual object may not be displayed;
a list of placement positions within the virtual environment at which a branded virtual object may not be displayed;
a list of restricted words;
a list of restricted brand names;
a list of restricted products; and
a list of restricted physical redemption locations.

6. The method of claim 1, wherein the advertising opportunity is selected from the group consisting of:
a menu position within an in-game menu for displaying a branded virtual object;
a placement position within the virtual environment for displaying a branded virtual object;
a digital coupon to redeem against a price of a physical good or a service;
an incentive to purchase a physical good or a service;
an advert for a physical good or a service; and
a pop-up offer that is presented to a user of the computer-implemented game.

7. The method of claim 6, wherein the offer attributes further indicate at least one of:
a unique identifier for a physical good or a service associated with the advertising offer;
a market restriction that indicates a set of venues at which the digital coupon is not to be presented;
a game state of the computer-implemented game at which the digital coupon is to be presented to a user;
a coupon price for the physical good or service of the digital coupon;
a bid price for an advertising event associated with a user of the computer-implemented game; and
a bid price for an incentive that is offered to the user to encourage the user to perform an action associated with the advertising event.

8. The method of claim 1, wherein the offer attributes indicate a bid price for an advertising event associated with a user of the computer-implemented game, the advertising event being selected from the group consisting of:
receiving a confirmation that the user has visited a physical location associated with a digital coupon;
receiving a confirmation that the user has scanned a code attached to the physical good provided by an entity associated with the service;
receiving a confirmation that the user has purchased the physical good or service;
displaying a point-of-sale (POS) message to the user in response to the user purchasing the physical good or service; and
sending a follow-up message to the user in response to the user performing an action that causes a first advertising event.

9. The method of claim 8, wherein the follow-up message is selected from a group consisting of:
an electronic-mail message; and
a message provided to the user via a computer-implemented social network; and
wherein the follow-up message includes an incentive to encourage the user to perform an action associated with a second advertising event.

10. The method of claim 8, wherein the method further comprises:
based on receiving a confirmation that the user has purchased the physical good, providing the user with a virtual object version of the physical good.

11. The method of claim 6, wherein the offer attributes include a bid price for an incentive that is offered to the user to encourage the user to perform an action associated with the advertising event, the incentive being selected from the group consisting of:
a virtual object;
virtual currency; and
character energy.

12. The method of claim 7, wherein the offer attributes further indicate at least one of:
a number of users required to purchase the physical good or service before the incentive is distributed;
an expiration date for the incentive;
an on-line relationship required between two users in the required number of users;
a game state associated with a user in the required number of users; and
a minimum level of in-game social interaction from the required number of users.

13. The method of claim 7, further comprising generating analysis data based on advertising events associated with a plurality of users of the computer-implemented game, the analysis data including at least one of:
the unique identifier for the physical good or service;
a scan frequency for the physical good or service;
a purchase frequency for the physical good or service;
a purchase repetition period for the physical good or service;
context information associated with scans of the physical good or service; and
context information associated with purchases of the physical good or service.

14. The method of claim 1, wherein the selectively accepting of the advertising offer from the advertising entity comprises:
determining that the advertising offer is appropriate for a user of the computer-implemented game based on one or more of:
a game state associated with the user;
demographic information for the user; and
an expected redemption value of an incentive that is offered to the user; and
determining that the advertising offer is appropriate for the computer-implemented game based on one or more of:
an inventory constraint;
metadata that describes the computer-implemented game; and
a unique identifier for the physical good or service.

15. The method of claim 14, wherein the determining that the advertising offer is appropriate for the computer-implemented game comprises:
determining classification data for the physical good or service identified by the unique identifier;
determining that the inventory constraint indicates an available inventory for an advertising offer associated with the classification data; and
determining that the classification data is in-line with a game theme or marketing strategy indicated by the metadata.

16. The method of claim 1, wherein the virtual object includes a virtual object that is provided by the computer-implemented game, and is customized by an advertising entity from which an advertising offer is received; and
wherein the offer attributes further indicate a skinning image used to customize the branded virtual object.

17. The method of claim 1, wherein the selectively accepting of the advertising offer from the advertising entity comprises determining that the advertising offer does not violate an opportunity constraint of the advertising opportunity.

18. The method of claim 1, wherein the receiving of the advertising offer comprises:
receiving an offer-placing script from the advertising entity, wherein the offer-placing script includes a condition indicating when to generate the advertising offer, and includes an action to perform to generate the advertising offer; and
responsive to determining that the condition of the offer-placing script is met, executing the action to determine a set of offer attributes for the advertising offer.

19. The method of claim 18, further comprising executing the offer-placing script to update offer attributes of an existing advertising offer.

20. The method of claim 1, wherein the advertising opportunity is a complex advertising opportunity comprising a sequence of advertising opportunities, a subsequent advertising opportunity being presented in the virtual environment in the event of a player interacting with the complex advertising opportunity.

21. The method of claim 1, wherein the advertising offer for the advertising opportunity is auctioned in an advertising market place.

22. An apparatus comprising:
a storage module to digitally store opportunity constraints for an advertising opportunity, the advertising opportunity indicating an opportunity to place a virtual object in a virtual environment of a computer-implemented game;
an interface module configured by at least one processor to receive, from an advertising entity via a network, an advertising offer for the advertising opportunity, the advertising offer including offer attributes that indicate at least a virtual object for the advertising opportunity and the computer-implemented game; and
an offer-processing module to accept, automatically using at least one processor, the advertising offer from the advertising entity based on the offer attribute indicating the computer implemented game and the opportunity constraints, the interface module being further configured to provide the virtual object of the advertising offer to a client device for inclusion in the virtual environment of the computer-implemented game.

23. The apparatus of claim 22, wherein the storage module includes a database configured to process a search query for an advertising opportunity, the search query indicating at least one opportunity constraint.

24. The apparatus of claim 23, wherein the storage module is further configured to store a plurality of advertising offers, and to process a search query for an advertising offer based on a search query indicating at least one offer attribute; and
wherein the interface module is further configured to use the storage module to store the advertising offer from the advertising entity.

25. The apparatus of claim 24, wherein the selectively accepting of the advertising offer comprises:
generating the search query for the advertising offer based on the opportunity constraints of the advertising opportunity;
processing the search query using the storage module to generate search results that include at least one advertising offer; and
selecting the advertising offer from the search results.

26. The apparatus of claim 22, wherein the selectively accepting of the advertising offer comprises determining that the offer attributes of the advertising offer do not violate an opportunity constraint of the advertising opportunity.

27. A computing system to process offers for an advertising opportunity in one of a plurality of computer-implemented games, the system comprising:
means for storing opportunity constraints for an advertising opportunity, the advertising opportunity indicating an opportunity to place a branded virtual object in a virtual environment of a computer-implemented game;
means for receiving, from an advertising entity, via a network an advertising offer for the advertising opportunity, the advertising offer including offer attributes that indicate at least a virtual object for the advertising opportunity and the computer-implemented game;
processor means for accepting the advertising offer from the advertising entity based on the offer attribute indicating the computer implemented game and the opportunity constraints; and
processor means for including the virtual object of the advertising offer in the virtual environment of the computer-implemented game.
